(19) United States
(12) Patent Application Publication
(10) Pub. No.: US 2004/0093247 A1
(43) Pub. Date: May 13, 2004

(54) Method of developing services on an infrastructure

(75) Inventor: Nicolaius Henricus Gerardus Baken, Voorburg (NL)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: Koninklijke KPN N.V.

(21) Appl. No.: 10/652,871

(22) Filed: Aug. 29, 2003

Related U.S. Application Data
(60) Provisional application No. 60/407,779, filed on Aug. 30, 2002.

(51) Int. Cl. G06F 17/60

(52) U.S. Cl. 705/7

(57) ABSTRACT

This invention discloses a method of developing services on an infrastructure. The method consists of defining a model for the infrastructure with three dimensions. The dimensions represent the following:

a first dimension relates to a topographical architecture of the infrastructure,

a second dimension relates to a number of main functions which have to be performed in the infrastructure, and

a third dimension relates to a role which parties involved in developing said services can play.

The next item in the method is playing of a game to develop said services that are financially validated.

This application invokes the priority of U.S. provisional No. 60/407,779

### FIELD OF THE INVENTION

This invention relates to a method for developing new or redesigning existing services on infrastructures.

### BACKGROUND OF THE INVENTION

### Introduction

Infrastructures provide for the basic, predominantly primary needs of society. Individual citizens make collective use of infrastructures, because this is more efficient than meeting the needs of each person individually. This means that any end user will not himself lay an asphalt road from The Hague to Groningen to travel between the two towns, and we no longer lay the water pipes to our own houses etc.

This contracting-out does however have its price and makes it difficult to make substantial innovations; this price has everything to do with increasing administrative complexity resulting from the separation into infrastructures and the autonomous developments of each infrastructure.

Costs and use of the infrastructures are divided, because their construction and operation are labor- and capital-intensive. The main infrastructures for water supply, agriculture, waste, energy, transport, building, health care, education and Information and Communication Technology (ICT) have grown up separately, because the “contracting-out” of the various basic requirements of a collective infrastructure occurred at different times. Roughly speaking, a logical time sequence can be correlated with Maslow's pyramid.

An infrastructure for water existed before that for transport, and the latter existed before that for ICT. Structured studies which do not methodically scrutinize existing infrastructures, taking the collection of “basic and higher needs” as a starting point, are not common. In this invention this is certainly done; we discover the concept of Unified Infrastructure and the first steps towards this are outlined.

### Historical Developments

In the process of human evolution, living together in (fairly) large communities, such as villages and towns, is, relatively speaking, a very recent development. Village communities were formed gradually after the last ice age, some twelve thousand years ago. With this development it became profitable to organize labor-intensive (and later capital-intensive) services providing for life's primary needs into infrastructures that encouraged the sharing of the services by the community as a whole.

In the first instance, consideration was given to providing the water required, the creation of fields, building processes, the removal and processing of waste. These were followed later by the provision of heat, light and power (electricity), organization of transport(facilities) and post.

### Traditional Infrastructures and the ICT Infrastructure

Besides the above-mentioned basic requirements, relatively recently a new requirement has arisen, namely the specific ability to communicate by means of language, images and data. The underlying infrastructure in this case is an Information, Communication and Telecommunication (ICT) infrastructure.

This last infrastructure is subject to many technological developments, one of the greatest challenges being migration from a narrow-band Public Switched Telephony Network to a broadband data infrastructure to allow narrow- and broadband language, data and image services.

The provision of glass fibers to end users—Fiber to the Home—has made it possible to supply services at speeds greater than 10 Mbps.

The ICT infrastructure and in particular the services made possible by it are already having a perceptible impact on the above-mentioned older infrastructures.

Due to the dynamics of the new services and the desired speed of implementation, the Next Generation Infrastructures, in this case the Next Generation Networks are being built up in layers. The vertically integrated infrastructure of the incumbent telephony, data and CATV operators is thus gradually being split up into a number of layers: horizontal integration.

### ICT Infrastructure

The fact is that the PSTN network is now still the most important; this network has grown up over the last 120 years and has some 1,000,000,000 connections world-wide! Besides conventional telephone traffic, a great deal of internet traffic also passes over this network. From a geographical point of view, the network is divided into various sub-networks. A core network that connects exchanges, and a terminal network that connects terminal exchanges with the customers. This last section still consists predominantly of copper wires. The speeds of transmission over this terminal network can be increased using what is known as xDSL techniques, with which speeds of the order of 1 to 2 Mbps can in principal be reached reasonably generically.

### SUMMARY OF THE INVENTION

Large complex projects with a lot of participants also called “multi-actor environments” sometimes are unsuccessful. Although participants in these type of projects may have mutual highly different interests, they also do have, generally speaking, one interest in common: successful completion of the project is of paramount importance to all of them. Failures are often caused by the fact that different participants have different ways of conducting their businesses, carry their own organization's culture with them, speak, one may say, a “different language”. For example, while building a large network for mobile telecommunication, government officials, landowners, network service providers, vendors of mobile phones etc. may be involved. Mutual incomprehension may result in mutual distrust. This may at least severely impair communication and cooperation between participants and, worst case, eventually result in project failure.

The present invention seeks a way of avoiding such a disadvantageous situation. It is also an aim of the invention to model an infrastructures to gain a better insight into, and be able to cope with, the complexity of infrastructures.

It is a further aim to provide the participants with an insight into each others roles and their own role while realizing complex projects and provide them with the understanding that they need each other in order to achieve successful completion of these projects. These projects may involve infrastructures.

This aim is realized by a method of developing services on an infrastructure by:

defining a model with three dimensions, in which

a first dimension relates to a topographical architecture of the infrastructure,

a second dimension relates to a number of main functions which have to be performed in the infrastructure, and

a third dimension relates to a role which parties involved in developing said services can play, and

playing a game to develop said services that are financially validated.

### BRIEF DESCRIPTION OF THE DRAWINGS

The invention will now be explained with reference to the accompanied drawings, in which:

FIG. 1 shows typical infrastructures (transport, energy and water),

FIG. 2 shows different layers and roles for an ICT infrastructure,

FIG. 3 shows a cube model of dimensions,

FIG. 4a, 4b and 4c show the functional decomposition of vertically integrated monoliths in the ICT world and the subsequent horizontal integration,

FIG. 5a shows the evolution of various types of infrastructures,

FIG. 5b clarifies the evolution of an infrastructure designed for ICT,

FIG. 6 clarifies changes in a traditional (ICT) infrastructure,

FIG. 7 explains the difficulties and proposed solutions in connection with a so called “multi-actor environment”,

FIG. 8a and 8b show how playing a simulation game may result in enhanced communication between previously isolated layers in ICT,

FIG. 9a and 9b show the game of FIGS. 8a and 8b applied to other infrastructural worlds,

FIG. 10a shows a combination between different infrastructures, FIG. 10b shows the historical (bottom up) development of an infrastructure, FIG. 11a and 11b show a top down approach to development of a unified infrastructure and

FIG. 12 shows an old service versus a new emerging service.

### DETAILED DESCRIPTION OF THE PREFERRED EMBODIMENTS

### Trends in Separate Infrastructures

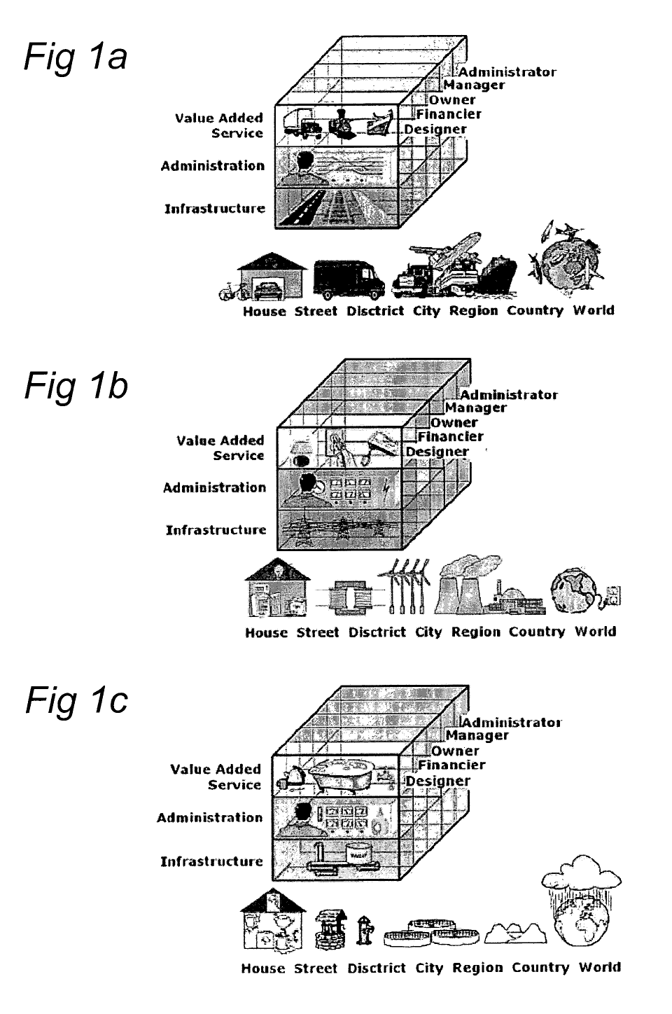

FIG. 1 shows infrastructures that are different for water, waste, transport, building and ICT. These infrastructures are all capital-intensive and provide for the basic needs of society. Each infrastructure originated at its own particular time and followed its own development. In each infrastructure it is clear that the techniques used are following each other more and more rapidly, and increasing in complexity. By making the right substitutes for the jargon typical of each infrastructure, it becomes clear that the developments and trends for nearly every infrastructure are almost identical and that the differences are chiefly a matter of pace. Comparing these infrastructures with each other also reveals the rationale behind the development.

The reasons why these infrastructures came into being is evident. It is after all obvious, with a limited number of skilled workers, to design, build and operate an infrastructure, so that the basic needs of many can be provided for. This development makes it possible for more varied and dynamic services to be offered. Different forms of separate infrastructures are shown in FIG. 1

Across the infrastructures a number of common trends can be observed: the growth in the number of end users and the extension of the provisions over several villages and later towns, made further division of tasks necessary: wholesale and retail were born, a first decomposition in the value chain and indeed a function decomposition.

As a result of the growth in scale (number of users, geographical spread) and diversity (several water products with different qualities), there is a steady increase in professionalisation and finally industrialization, which is institutionalized in ever greater enterprises.

In the end these enterprises acquire a national scale. True, they recognize the various functions “from ground to customer”, but they perform them all within a large, completely vertically integrated enterprise. It is characteristic of this kind of enterprise that they are more infrastructure- than service-oriented, and can therefore become unwieldy. It is difficult to introduce new products, because to do this almost all the links in the chain require innovation. Such enterprises may therefore have little inclination to change. However, at the top of the chain impetus is increasingly provided by an ever more mature end user, a growing need for separate or more differentiated services and more competition. Splitting the enterprise into two or more functional layers appears inevitable if innovation is not to stagnate. The vertically integrated enterprise will show (horizontal) break lines.

In time, in each of the functional layers it is discovered that those responsible for the function(s) expected of that layer by the layer above form a team: each player has his or her own role. This means subsequent desegregation within the wholesale and retail layers. Generically a number of roles are based on specialisms such as: design, finance, administration (initial and continuous supply), and operation.

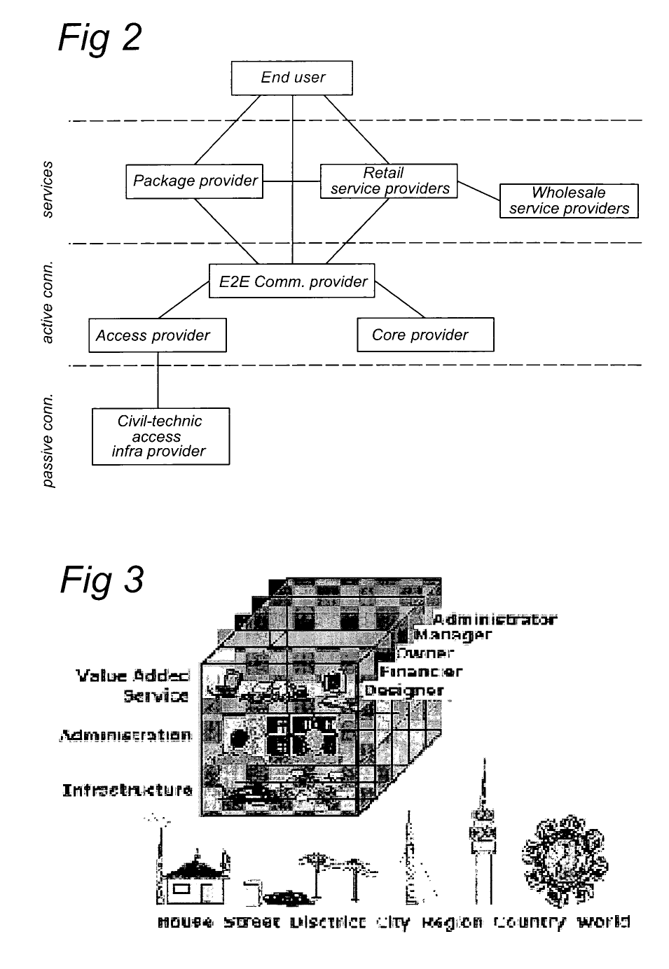

In FIG. 2 this may be illustrated as an example for the world of ICT. In the world of telecommunications, the number of applications of the cash-cow speech (and other telephony services) over the Public Switched Telephony Network (PSTN) is rapidly increasing. These Value Added Services for the retail market form a spectrum of narrow- and broadband services, making function decomposition inevitable: an unbundling of the vertically integrated value chain. A simple example: for each new service, no extra copper, coax, or fibers will be laid, anyone can see that it would not make sense. (New) services will increasingly make use of the underlying OSI-layers. Even in the old PSTN this has already become apparent within the exchanges used: service control is, as it were, freed and taken out of the exchanges using the Intelligent Network concept. Basically function decomposition goes ahead, producing a simplified form in three layers: one layer for the basic infrastructure, one layer for Administration, so that bandwidth and e2e connections (the wholesale generic bearer services) are possible, and finally a layer for the (predominantly retail) Value Added Services.

Basically, the following paradigmatic changes from the old to a new ICT world can be identified. In the commercial portfolio we are migrating from narrow-band speech and best effort data services to “carrier grade quality” broadband services (this refers to “telephone quality” which must be consistent, because the future generation of multimedia applications are the company's lifeblood); in the technical portfolio, from copper to glass (also called: Fiber to the Home—see attached role model and FIG. 2) and broadband mobile Access networks; in the operational portfolio from decentral administration to central administration and in the financial portfolio from closed to open business models. And finally, in the administrative portfolio, “vertically integrated chains” migrate in the hands of a few dominant market participants into horizontally integrated layers by means of a function decomposition in the value chain; in each of the layers, several specialist market participants are active. The Value Added Service, the retail service to the customer, can only come into being through cooperation between the actors across the functionally decomposed layers; a price has to be paid for this, namely the price of administrative complexity.

### Decomposition of Infrastructures and the Infra-Cube

In each of the above-mentioned infrastructures and in accordance with the present invention, three dimensions are identified. A first dimension relates to the topographical architecture of the infrastructure. Infrastructures extend from a rural to an urban level, finally coming into each individual house. It is possible, depending on the extent of (inter)national planning or organization, to extend this dimension by several levels such as region and district. From the customer's point of view we can then sum up as follows: house, street, district, town, region, country, continent and “globe”. It may be clear that the architecture for each element in this summary is different. An example from the ICT sector: an in-house network is something totally different from an international back-bone network. So we can associate this dimension with the technical portfolio (with what, which technology).

A second dimension relates to a number of main functions which have to be performed in the infrastructure. Within the ICT infrastructure, reference is frequently made to the OSI model. In this model, which consists of seven layers, each overlying layer makes use of services from an underlying layer. So we can associate this dimension with the commercial portfolio (what, which service).

In other infrastructures use is made of similar layer models, although the number of layers is usually smaller. In this essay we are using a three-layer model which can generally be applied over all the infrastructures. The main functions included in this are: the actual infrastructure at the lowest layer (“the factory”), the administrative layer and the topmost layer which contains the Value Added Services (“the retail”).

The third dimension includes the roles which the parties can play in bringing about the whole process, i.e. allowing the whole chain to operate in the infrastructure world. It is after all necessary for a basic infrastructure and the overlying layers to be designed, financed, built, operated and managed. So we can associate this dimension with the operational portfolio (how, with which process). In other infrastructures use is made of similar layer models, although the number of layers can differ from 5 to 12.

Thus three universal dimensions are identified:

1. The topographical dimension (with what/which technology/technical portfolio/investments)

2. The OSI dimension (what/which service/commercial portfolio/turnover/functions)

3. The roles dimension (how/what process/operational portfolio/operating costs)

Note: in the infrastructure we will find investments, in the administration there are the operational factors, the VAS deliver turn over. The role axis is in the administrative portfolio.

FIG. 3 is a graphic representation of these dimensions. The representation has the form of a cube.

The above-mentioned list of water, energy, transport and waste etc. infrastructures is certainly not complete. For example, infrastructures for education and health care can just as well be added. A specific aspect of this kind of infrastructure is that the topographical dimension of an infrastructure does not always have to be physically filled in with a tangible infrastructure. It is perfectly possible for it to be completely or partially filled in “virtually” by, for example, ICT. One example is a number of ICT provisions in the home, that enable medical care to be provided remotely at home. The model thus appears consistent and even provides new ideas if we carry it through logically. The development, history and status-quo of an infrastructure in the cube model are described, and desirable future developments can be generated by looking at quantitative and qualitative differences over time in each dimension (deltas).

Despite the possibility of describing infrastructures uniformly, it may at first appear that one or even more infrastructures fit less well into the cube model, because one of the dimensions is more difficult to interpret. Think for example of the building infrastructure. How must the topographical dimensions be interpreted? Is it a question of a few houses, a street, a district, a town, a region or conurbation, a country or the globe? At present this kind of development of this dimension for the building world is not (yet) opportune, because it has neither virtually nor physically extended its infrastructure to the home. This does not alter the fact that such an ambition cannot be fulfilled, certainly when it becomes desirable to build up a longer term relationship with the buyer (read retail customer) and later the inhabitant. The same applies to the infrastructure for health care. Permanent preventative and direct health care provided remotely do not at present exist. But once this is the case, all the elements from the topographical dimension will have to be filled in.

### Administrative Complexity

Complexity is a “normal” phenomenon in our present-day society. Being able to get on with . . . that is the art.

The basis of many of our problems and complex systems can be ascribed to the fact that we have decomposed the “holism” (functionally) in terms of quantitative (scale) developments and qualitative developments (increasing sophistication and granularity). These developments are to be found in almost all infrastructures. The turbulent developments in the ICT industry, in services (e.g. mobile applications), technology (e.g. broadband), administration (multi-actor environment) and legislation (e.g. liberalization) are causing a true paradigm shift. This results not only in several service providers wanting to make use of the same network, but also in network operators sharing (or wanting to share) their networks with others. A shortage of financial resources forces many parties to make a choice between consolidating or innovating with others.

Causes of administrative complexity in ICT are for instance:

parties affected by knowledge deficit

no picture of the control system in the chain

lack of empathy for each other's functions and roles

insufficient insight into the complexity

insufficient awareness of the need for a shared interest: one common objective

not understanding the need for cooperation

not really taking the end user's interests on board

These causes are, however, not ICT specific. In general, when several parties are involved in realizing large infrastructural projects, the causes listed above may pose serious problems.

The price which has to be paid for the function and role decomposition is that of administrative complexity. It is no longer the norm for a single party to provide one service (speech) via a completely vertically integrated operating column over one network.

Administrative complexity comprises the clustering of related functions with choices for the correct roles. From the decomposed parts, with a consortium of actors and players, a single whole must again be made to bring the applications to the customer in time, tailored to requirements, and at a fair price. In academic terms, two puzzles need to be solved:

a) Finding the correct, optimum decompartmentalisation of the cube into a realistic number of compartments, say 4 to 7 clusters,

b) The mapping of suitable actors and players to the clusters and the connection of the clusters and actors into a practicable business chain which “works” not only as a whole, but also for each individual cluster.

Presently, no solutions are available for these problems neither in the organization of enterprises themselves nor for the whole chain. A choice also has to be made as to the correct and desired roles in such a newly formed (harmonious) business chain.

The following questions play an important role here:

who should be in control . . . ?

must it be the market . . . ?

what about market forces . . . ?

For all kinds of reasons (see examples above) this is not succeeding at present. Stagnation is occurring in pilot schemes in “kenniswijken” (smart neighborhoods) (Eindhoven, Almere etc.), market participants are struggling with their position and role in the world of broadband and in local and central government, which have no clear idea of the future and how to support the market participants. There is no single party with knowledge of how control needs to be exercised over the whole chain.

### Complexity and Emerging Properties

Presently, there is no solution. It is clear that a number of factors can be used to come to a solution:

actors have confidence in each other

actors are able and willing to work together

actors speak the same language and

all actors have the same objectives.

In addition, the parties (or “players”) need an environment (while speaking about parties as players, we may speak about a “game” as environment) in which the players can communicate about these aspects with each other. The filling in of these aspects across the functionally decomposed layers will ensure that life is put back into the new chain, just as a nervous system is necessary to activate the body.

In this way, a new Emerging Property arises. Old structures are replaced by new; the structure of the parts, i.e. the functionally decomposed layers (of infrastructure, administration and services) and the (virtual) nervous system together form the circulatory system which can transport the lifeblood of ICT to all customers.

### Future Developments, Outline of Unified Infrastructure

It has already been established that infrastructures each have their own pace of evolutionary development comprising identifiable phases. The most recent infrastructure is that for ICT provisions, which is having an increasing impact on the older infrastructures with the result that the latter are no longer separate from each other. More importantly, the moment has come to consider infrastructures integrally and possibly even to foster the ambition to achieve a Unified Infrastructure. This Infrastructure with a capital 1 is constructed on the basis of the higher requirements, or needs, of society. This is a way of thinking that takes place “top down” from a vision, as opposed to a “bottom up” composite of separate infrastructures. Such a new infrastructure produces considerable savings in the “bottom OSI layers” as well as new turnover flows in the higher OSI layers by the combination of business and consumer needs from one domain (infrastructure world A) with the technologies from another domain (infrastructure world B).

Complex, high added value services, which are provided to meet secondary needs, can thus be “composed”. The new combinations can be generated ad-hoc, (quick wins) or constructed “bottom up”, discovered by the Industrialization of Innovation method. This certainly results in savings and flows of income from new combinations, new services which integrate the technologies and requirements across the various Infra sectors, but no harmonious whole, no actual integrated infrastructure. In the case of an optimized Unified Infrastructure, this is derived top-down from existing and future desired needs. The first method (bottom-up) has a “technology-push” extrapolating character, and the second (top-down) method has a “market-pull” character, and leads to a Green Field Unified Infrastructure, an objective-infrastructure.

### Phases in Infrastructure

The various successive phases in the infrastructure worlds can be identified as follows:

1. institutionalization of provisions for basic needs in infrastructure enterprises

2. first function decomposition (unbundling) of wholesale and retail

3. horizontal integration within one infrastructure sector, industry

4. second function decomposition into roles (unbundling the unbundled), specialization in roles for design, financing, installation, administration, operation and control

5. horizontal integration across the infrastructure worlds, bottom up

6. redesign of the infrastructure in the direction of Unified Infrastructure, top down.

However this still leaves something to be desired: a vision of a Unified Infrastructure, which can be translated into a realistic mission to achieve such an integral infrastructure. The basic conditions for this are:

an insight into the genesis and operation of existing infrastructures

a common language in order to be able to set up communication between the separate worlds, and

confidence of the parties in and across the infrastructure sectors in order to create support for the joint accomplishment of the mission.

The evolution of different infrastructures has been outlined above. For language, a generic OSI model can serve, and to increase confidence an infrastructure game can be played. These two subjects are described in this patent application. We will thus make an excursion into the infrastructure game. As a methodology for the structured generation of the savings and new turnover flows across infrastructures, the process of Industrialization of Innovation is used: business and consumer needs from infrastructure A are combined with technologies from infrastructure B, to arrive at new combinations.

In the past for example, the ABC methodology and the Real Option Theory (which deals with modeling the price of options) have proven to be vehicles for the design and financial validation of the vision and mission. ABC methodology defines three situations:

A: the present situation as a starting point: “What business are we in?”

B: the desired situation that has to be achieved: “What business do we want to be in?”

C: the path that will take us from A to B while realizing our objectives.

### Unified Infrastructure Explained in Greater Detail

A bridge can be made to the future for the ICT world by means of the ABC methodology and the vision is financially validated by the Real Option Theory. Innovations which are needed for this can be generated by the process of Industrialization of Innovation. This process can be used uncurtailed in the other infrastructure worlds. Thus we make bridges to the future in each of the infrastructure worlds. Is this the ultimate objective? No! The moment has come to consider our basic needs integrally and so also to scrutinize the underlying infrastructures integrally, and thus to design a bridge to the future integrally across the infrastructures to the future.

In each of the infrastructure worlds we recognize that a combination of a technology and a (basic) need together always define a profitable service. Within an infrastructure world, many of the combinations can be generated as building blocks to examine new services. This is also known as “Ideation”. Now, by not restricting the field of vision to just one of the infrastructures, but looking simultaneously at them all, and thus at the whole abundance of technologies and needs, the number of combinations increases enormously at a stroke. We can also look at it differently.

Value added services can be defined as services that provide for secondary needs, needs that are placed higher in Maslow's scale. Basic services originally provided by (certainly the older) infrastructures meet primary needs. Needs can be pushed downwards in Maslow's terms, www.chimaeraconsulting.com/maslow.htm. Each value added service is to be decomposed into basic services which, as it were, form the basis of the higher value added services. The decomposition of such a complex service into underlying services, each of which in turn represents a combination of a technology and need will generally not fall within a single domain, or infrastructure. We are thus, as it were, extending the tool box to build up new services which can provide for the needs of industry or society. Market Pull (discovery of new needs in the market) and Technology Push (thinking based on the large toolbox available) can complement each other in this process. How then is the solution space, the space to be spanned by new services immeasurably increased at a stroke by viewing the infrastructures integrally. However, this does not make a Unified Infrastructure an objective in itself! Where separate infrastructures are an advantage, we leave things as they are! However the latter can precisely be a result of integrally considering the infrastructures and the services which they integrally make possible; the needs and the value added services then serve as starting point (market pull).

### Infrastructural Game Explained in Greater Detail

To clarify the concept of unified infrastructures, the inventors have developed an infrastructural game. The participants in this game (players) may be given as an assignment to represent, individually or as a small group, a particular party (to be) involved in a complex project. For instance in the case of a large ICT project, one player may represent a supplier of fibber glass, another can be a bank, one player may be a governmental agency, one player can be a vendor of broadband communication capacity, a further player may be a provider of all kinds of digital services (e.g. video on demand or weather forecast by SMS etc.). All these players have a different organizational background and different requirements with respect to for instance return on investment periods and the like.

In a first round of the game, all players together have to think up services which they see as potentially profitable. The inventors have, e.g., found that 20 players came up with 40 to 50 examples of possible services in only one hour, which is an advantage. In the first round, while the players are communicating with each other different opinions as caused by different interests are brought forward. Some type of service may not be acceptable for one player while perfectly acceptable for another. For every service that is developed, on the basis of the type of service, the price of the service and an indication of market share/penetration, a curve is calculated that represents the market growth of the service as a function of time. A price (or price category) for the individual service is determined by the players. The service may be available by subscription or may be a service that is paid for only once. The game also comprises a game management team that may correct unrealistic indications of market penetration. The output of the first round is data concerning forecast on market development for (as an example) 5 years and estimated turnover. This gives an indication as to whether how/when a service will be profitable.

In a second round each player is given a budget. On the basis of the services which were conceived in the first round the players have to decide which service they will adopt, and who will pay what costs. The inventors have observed in various games that due to the scarcity of the money, conflicts develop. It is among others an aim of this second round to develop a kind of mutual understanding and mutual thrust between the players. This may lead to types of services in which all players participate with a different amount of money. Returning once more to the example of ICT, a service provider may have to pay already in the beginning for the construction of a glass fiber network. Due to the large risks (e.g. financial risk, risk of realization time longer than planned) involved a good relationship between the players is important. The purpose of the game is to let the players participate in a process in which they have to accomplish a common goal with limited resources. Several changes in the game are possible. As an example a player may have more than one interest (for instance a network constructor with a share in a service provider). It is also possible to conduct bidding rounds after each bidding round the player may change their prices and or amount with which they participate in a service. Another possibility is a player that does not sell services but rents services. By playing the game an insight into the genesis and operation of existing infrastructures is developed. Also, players will improve their mutual communication processes because they will have a common language which enables to set up communication between the separate worlds. Besides, confidence of the parties in and across the infrastructure sectors will be increased which creates support for the joint accomplishment of the mission, such as the realization of a complex multi participant infrastructural project. In particular, using (playing) the game makes the realization of all types of realistic (financially feasible) services on present (or future to be adapted) telecommunication networks (infrastructures) possible. Beforehand, the participants/players will have an insight into the prospective costs and profits (as a function of time). This is advantageous, as this will avoid unnecessary investments in infrastructures by mapping needs on possibilities with an idea of costs involved and profits to be expected in advance. Also, project failure is prevented as potentially causes of conflicts are eliminated thus reducing the risk of an impossible situation.

The above is shortly summarized in that structured studies which do not methodically scrutinize existing infrastructures, taking the collection of “basic and higher needs” as a starting point, are not common. In this invention this is certainly done, and the concept of Unified Infrastructure is discovered. The business modeling method of this invention defines structures, preferably cubes, with the following dimensions:

(1) OSI model (differentiating between services level and infrastructure), (2) role (different parties, such as local authority, user, value added provider, subsidy provider, etc.) and (3) scope (street, town, country, etc.).

The structures (cubes) are used to model various kinds of infrastructures (Unified Infrastructures). Each infrastructure has its own structure (cube) with the objective of gaining more insight into the complexity of the infrastructures.

Now, the previously explained concepts will be clarified in more detail with reference to the following drawings.

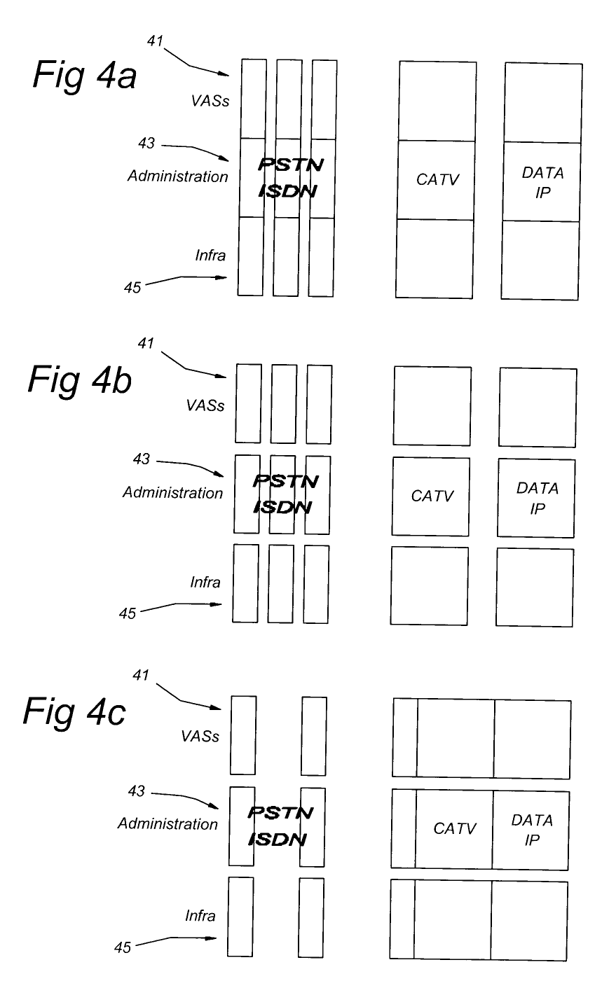

In FIG. 4a is shown how monolithic, vertically integrated enterprises are typically organized. Each enterprise comprises an upper layer 41, a middle layer 43 and a bottom layer 45. The example from FIG. 4a relates to enterprises operating in the field of ICT. The different layers 41, 43, 45 perform different functions. The upper layer 41 in FIG. 4a represents the Value Added Service (or “VAS”) layer, the middle layer 43 the administration layer and the bottom layer 45 is the infra(structure) layer. All the layers are part of one single enterprise. To illustrate this point be it known that, before 1989, there were in the Netherlands (roughly speaking): one Telecom actor: the state enterprise PTT Telecom offering one service: (speech) telephony (POTS: Plain Old Telephony Service), which was supplied via one network: the PSTN (Public Switched Telephony Network) of PTT Telecom. PTT Telecom was vertically divided in columns such as telephony, fixed connections data, etc. all operating within their own allocated territory. Other enterprises offered other services, such as for instance CATV (TV by cable) or data services by an international company CompuServe.

The situation has now drastically changed. Telecommunication has become ICT, and instead of a single service (telephony) many services are possible: multi-services. These services may be categorized into speech, data and image services and are known collectively as multimedia services. It is clear that a separate network for each of these services cannot be the solution. This is why we see multi-service platforms arising where the infrastructure and the administration of the infrastructure are divided by the VASs, or Value Added Services. This is shown in FIG. 4b. Thus, in accordance with the OSI model we see a separated layer structure arising, which consists of: Infra(structure), Administration and Services. Agreements, known as Service Layer Agreements are essential for such a structure to become operable. This is illustrated in FIG. 4c where some of the individual blocks of FIG. 4b are horizontally integrated. As several actors are involved in each of the layers 41, 43 and 45 and each layer is a basic prerequisite for the connecting layers, the situation becomes increasingly complex. In brief, the customer can only be supplied with a service if each of the layers is functioning correctly and some kind of (service/business) control is exercised across the layers so that the heart of the ICT chain can beat. This is a new paradigm for the ICT world, people have not yet played with the new model. But playing with that model may gain insight into the complexity and the individual layers, responsibilities and roles, as well as gain insight into how the chain can work!

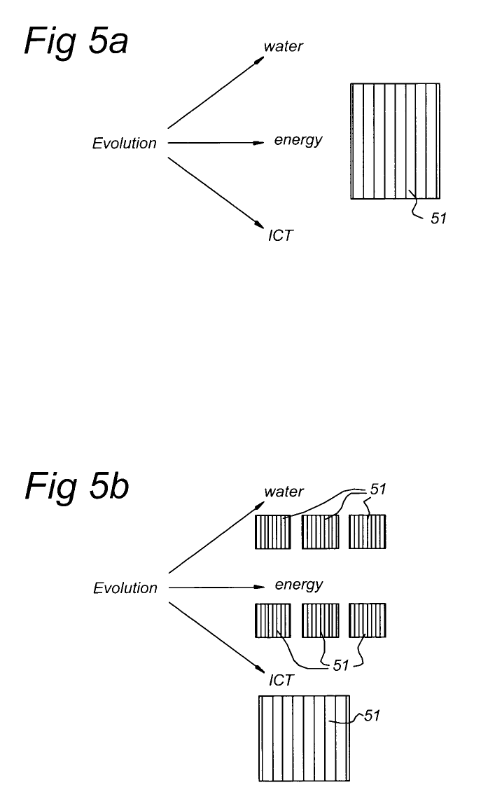

As shown in FIG. 5a such an approach is not applicable to the field of ICT alone: it is also common to several other large scale organizations that can be characterized as monopolists, are monolithic to a high extent, are vertically integrated and oriented on infrastructure rather than on service. They will evolve in a comparable manner. For example, enterprises in the field of waste, water, energy, construction, transport, agriculture, ICT, healthcare, education and others will show the same evolutionary steps in functional decomposition and role composition from “hunting” to villages to cities and further. Such a large scale organization is shown as a rectangle divided in vertical columns as indicated by reference numeral 51 in FIG. 5a. As shown in FIG. 5b several of such organizations 51 may operate within the same type of infrastructure e.g. water, energy, ICT.

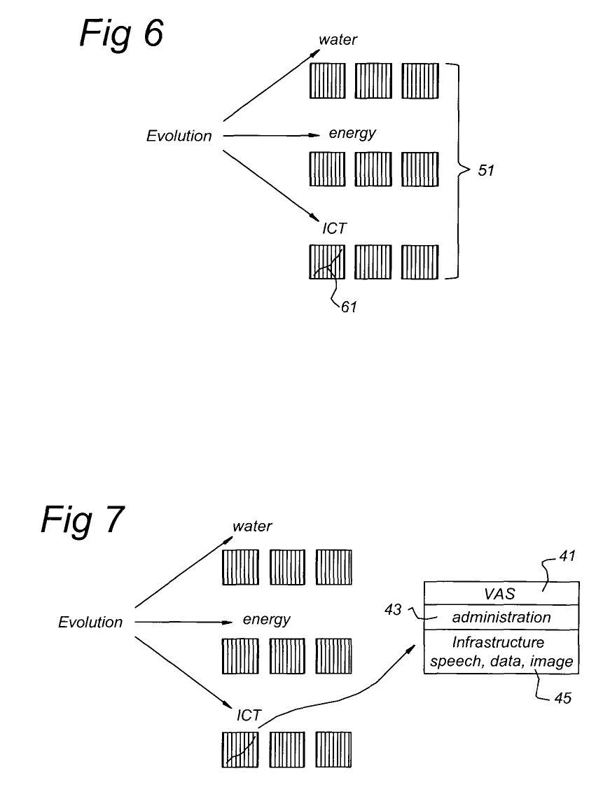

As shown in FIG. 6, the large scale organizations from FIG. 5 will eventually receive cracks in their vertical structures. Causes include the fact that customers ask, for instance, for more services, or more suppliers are entering the market, or more networks come into existence. Sticking to the example of ICT, where a crack in FIG. 6 is indicated by reference numeral 61, the crack may originate from customers who demand a increasing number of services such as voice dialing, voice recognition or fixed networks that have to be adapted for mobile communication. The latter is a simple demand that, however, requires a surprisingly huge amount of technical innovation.

As shown in FIG. 7 the old vertically organized ICT infrastructure evolves to a horizontal structure with layers 41, 43 and 45. In every layer 41, 43 and 45 more than one actor is present. An individual customer may thus receive invoices from three different organization. One invoice from an organization operating in the top service (VAS) layer 41, a further one from one in the administration (or “connections”) layer 43 and a further from one the infra layer 45. This is a rather obscure situation. Stagnation and deadlock due to administrative complexity may occur.

A helpful solution is provided in to overcome this situation. Referring back to FIG. 3, a 3-dimensional cube model is shown which is used to define roles and responsibilities for all the actors or participants in a particular infrastructure. On the x-axis the scale of operation has been listed: from house, street to district, city, region, country and world. The puzzle is now to map each concrete actor on each intersection of the different axes in the cube. Some actors have to invest a certain amount of money. In order to have a feasible infrastructure developed, no “vacancies” i.e. empty intersections are allowed. It is also important that actors/participants are aware of their particular position on an intersection in the cube.

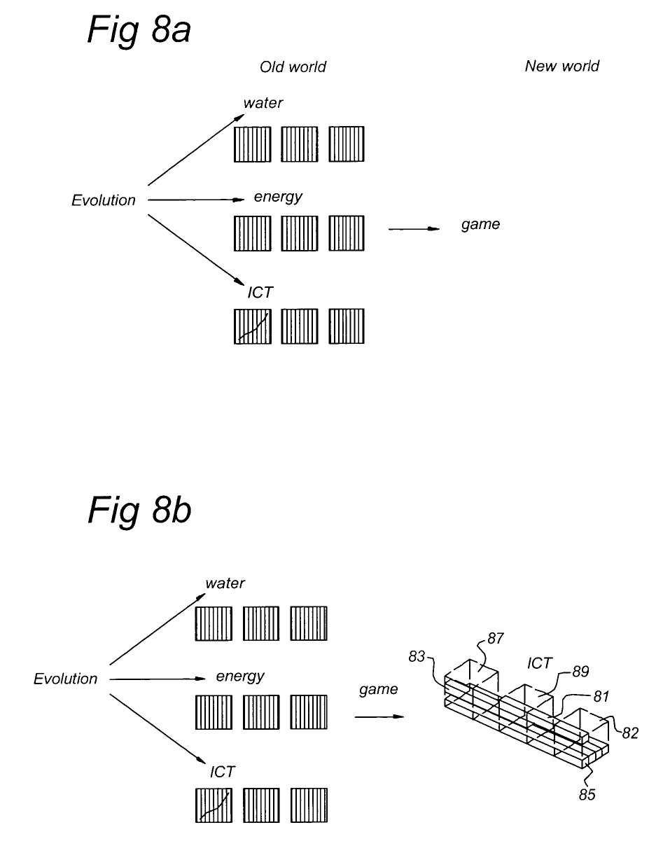

In FIG. 8a and following, the old world is shown in the left hand side of the figures. The new world in the right hand side. Since different actors may not thrust each other due to uncertainties about their new altered role or roles the inventor realized that a game could be developed to practice in confidence, working together, speaking the same language and deciding on and striving to common goals. The game is communication, impulse to the nervous system across the broken down layers. Opportunities that exist in the new world comprise different levels within and with local authorities, combinations in infrastructure and combinations from ICT to other infrastructures, and international opportunities.

In FIG. 8b, an ICT infra cube representing cable 87, internet 89 and telephony 82 is shown. The game that is played among participants will lead to the understanding that a more horizontally oriented approach can be beneficial to develop new services. In FIG. 8b, it is shown that there is a horizontal integration developed between these ICT infra cubes. This is indicated by the beams with reference numerals 81, 83 and 85. While working together, an integration is achieved. Functions and roles of the old world are decomposed. A vertical unbundling and a horizontal bunding is achieved.

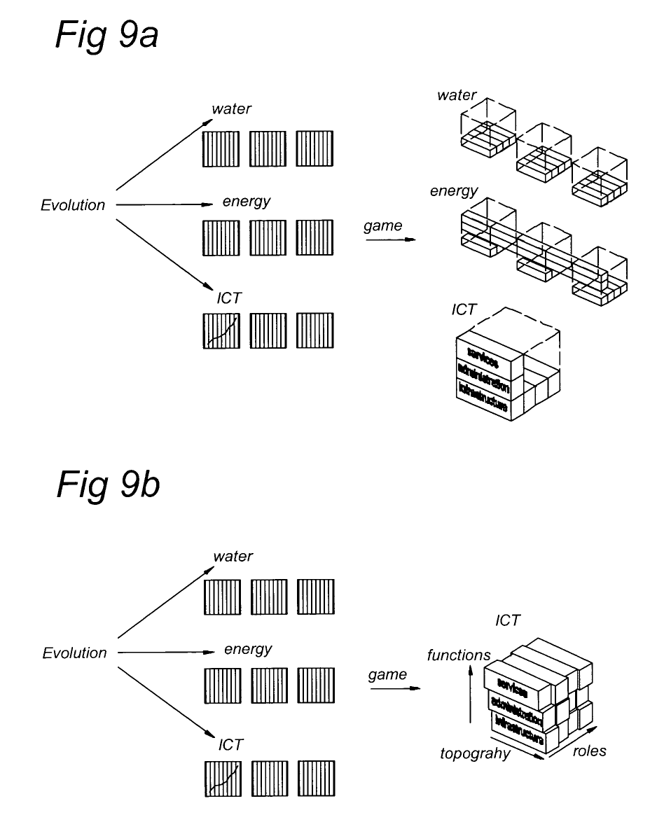

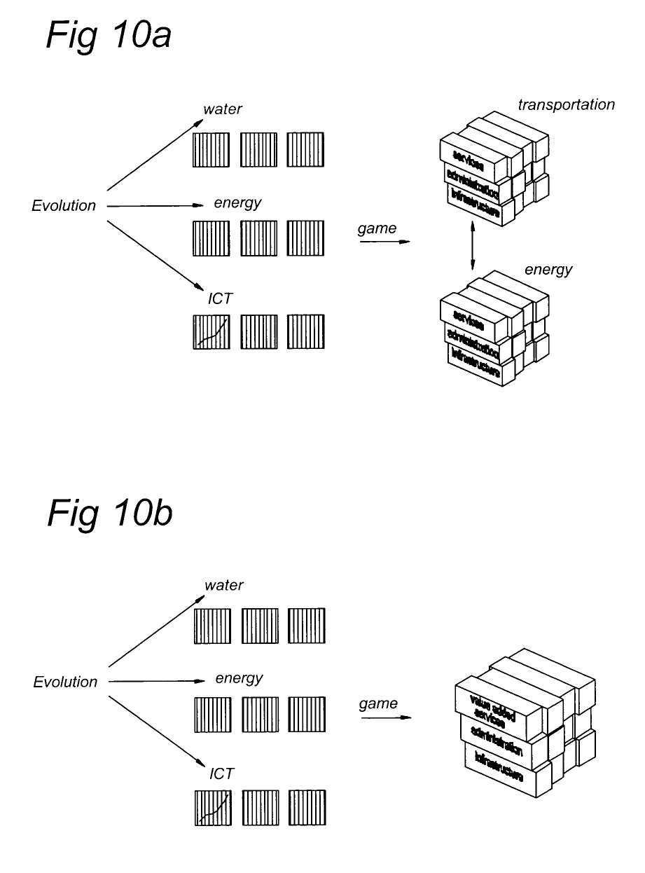

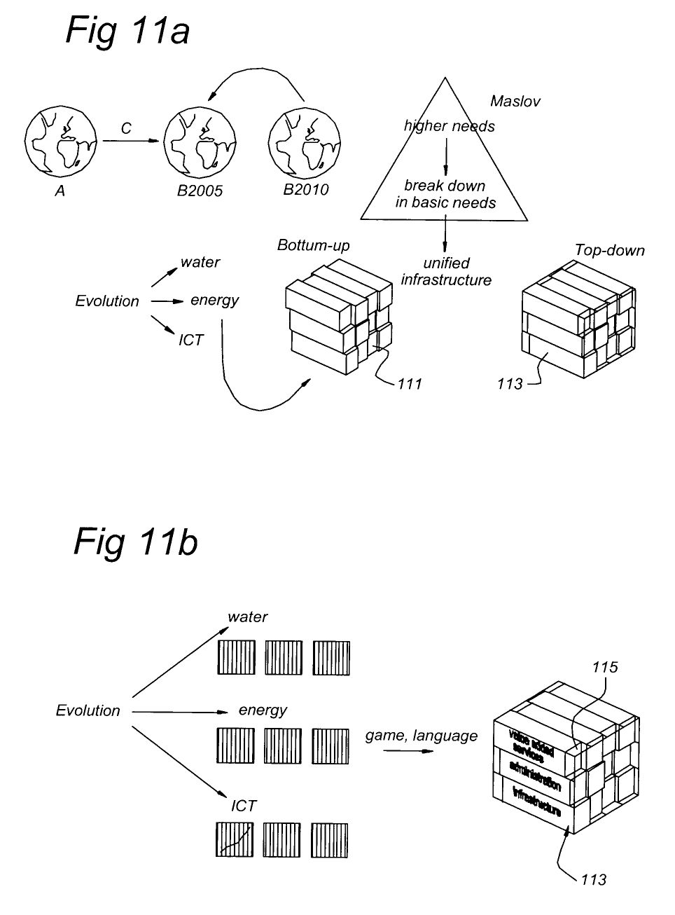

In FIG. 9a it is shown that not every infrastructure integrates at every level. In the water “world” as an example, integration is not achieved in between different infracubes. In the energy world it is shown that horizontal integration is achieved at the top levels. Also, in FIG. 9b an infrastructural cube for ICT is shown. However, although it resembles a cube to a high degree, and the three axes (functions, topography and roles) are present, the infrastructure is not an exact cube. There is some amount of friction between the layers and they join not into a complete cube. More than one party operates in the roles and functions axes. Also, more organizational forms are present in the topographical axis. In FIG. 10a, it is shown that combination between infraworlds are possible for instance energy and transportation. This is caused historically from considerations of efficiency and operational excellence. Such a bottom up approach may in the long run require excessive amounts of energy to get from the starting point via breaking down to a neat infrastructural cube.

In FIG. 10b, it is shown that layers as defined (see for instance in FIG. 4) integrate horizontally into beams. These beams however do not form a neat cube. This is a result from the bottom up approach. Once again, a game may be helpful in coming to this understanding.

FIG. 11a is an intermezzo with respect to the foundation of unified infrastructures. Shown in FIG. 11a is the approach in which one could develop an infrastructure without having to take into account the historical developments. This is an Utopia. But here one could work with the need profile of humanity as illustrated by the well known Maslow pyramid of needs. By using the top down approach it is possible to think backwards from the desired situation. Self fulfillment is decomposed in basic needs. The focus is in the future. At several stages, the question must be asked whether we are doing the right things. For instance, to arrive at the ideal situation for the world in 2010, referenced to as B2010 from now referenced to as A, it is straightforward to develop the route C from A to B2010. Several test stages for instance at B2005 are incorporated along the route C. If an event occurs that was not expected one may be forced to change the route C or arrive at a different B*2010. As an example there may be not enough services sold in the Value Added Service layer 41 which may mean an increase in activity there. To develop the route C the inventors have developed a third round in the game in which the participants develop a route towards an amended infrastructure allowing the services to be provided in the future. It is further shown in FIG. 11a that there is a difference between the cube structure 111 that results from a bottom-up approach in contrast to the neat cubic structure 113 resulting from a top down approach.

FIG. 11b illustrates as opposed to FIG. 10b, that use of the top down approach results in a neat cubic structure 113 for ICT, where the irregularities are filled. One of the many irregularities is referenced to as 115.

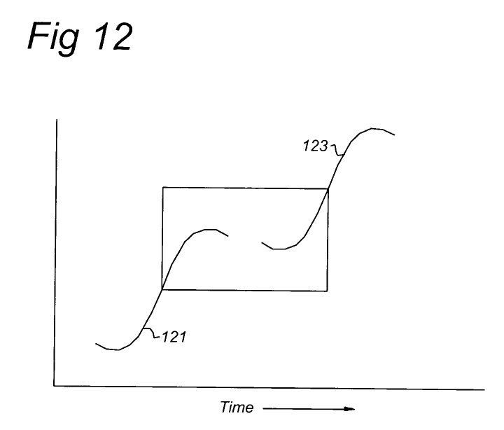

FIG. 12 shows what the concept of unified infrastructure can mean to businesses. To continue successful operation several changes are necessary. With respect to commercial portfolio in e.g. telecommunications, the focus must change from small bandwidth to broadband service. As far as technical portfolio is concerned, the focus must change form copper, coax to fiber and mobile access. The operational portfolio must change its focus from decentralized administration to centralized administration. The financial portfolio from a closed business model to an open business model. The administrative portfolio, traditionally having its emphasis on vertical integration must integrate horizontally which involves functional decomposition and role decomposition. Finally, where the business environment previously comprised a single actor, now a multi actor environment emerges. These changes will take a company by developing new profitable services from the end of a first S-curve 121 to the beginning of a second S-curve 123. The concept of an S-curve is well known from economics. It represents the typical life of a product or service. Sales of a product or service will be in the beginning low, then slowly sales will increase rapidly and more rapidly. Until at a certain moment in time, sales will begin decrease and the curve representing the relation between sales and time will level off.

1. Method of developing services on an infrastructure by:
defining a model with three dimensions, in which
a first dimension relates to a topographical architecture of the infrastructure,
a second dimension relates to a number of main functions which have to be performed in the infrastructure, and
a third dimension relates to a role which parties involved in developing said services can play, and
playing a game to develop said services that are financially validated.

2. Method according to claim 1 characterized by playing said game in accordance with the following actions:
mapping at least one of said parties to at least one of said roles to play,
generating ideas as to new, potential services on said infrastructures,
identifying costs and profits for said new, potential services,
selecting one or more of said new, potential services in accordance with predetermined selection criteria.

3. Method according to claim 1 characterized in that said infrastructure comprises an infrastructure for information and communication technology (ICT) services.

4. Method according to claim 1 characterized by using at least one of ABC methodology and Real Options Theory for design and financial validation of said new, potential service.

5. Method according to claim 1 characterized by playing the game in at least two rounds, wherein
in a first round said parties develop said services by mutual agreement
in a second round each of said parties is awarded only limited resources to realize said services in order to establish by mutual negotiations a hierarchy in said services.

6. Method according to claim 5, wherein said game comprises a third round in which said parties develop a route towards an amended infrastructure allowing said services to be provided in the future.

7. Method according to claim 1 characterized in that said second dimension comprises:
a first actual infrastructure layer,
a second administrative layer, and
a third value added services (VAS) layer.

8. Method according to claim 1 characterized in that said second dimension is the Open System Interconnection (OSI) reference model.

9. Use of a method of developing services on an infrastructure by:
defining a model with three dimensions, in which
a first dimension relates to a topographical architecture of the infrastructure,
a second dimension relates to a number of main functions which have to be performed in the infrastructure, and
a third dimension relates to a role which parties involved in developing said services can play.
